(19) United States
(12) Patent Application Publication
(10) Pub. No.: US 2024/0374936 A1
(43) Pub. Date: Nov. 14, 2024

(54) LOCKING MECHANISM FOR RESPIRATOR ASSEMBLY

(71) Applicant: Honeywell Safety Products USA, Inc., Charlotte, NC (US)

(72) Inventors: Oliver GOMEZ RODRIGUEZ, Mexico City (MX); Sergio Eladio ABURTO, Mexico City (MX)

(21) Appl. No.: 18/314,524

(22) Filed: May 9, 2023

(51) Int. Cl. A62B 18/08; A62B 23/02

(52) U.S. Cl. CPC A62B 18/08; A62B 23/02

(57) ABSTRACT

Methods, assemblies, and/or the like are provided. In some embodiments, a respirator assembly includes a connector having a connector base and a connector column, wherein the connector column has an inner and outer surface, and wherein the connector column defines connector threading on its outer surface. In some embodiments, the respirator assembly includes an adaptor including an adaptor base and an adaptor column, wherein the adaptor column has an inner and outer surface, wherein the adaptor column defines adaptor threading on its inner surface, wherein connector threading and the adaptor threading are configured to fit together such that the connector and the adaptor are operably engaged. In some embodiments, the respirator assembly includes a respirator cartridge having a housing defining a fitment portion configured to receive the adaptor column such that the respirator cartridge and the adaptor are operably engaged.

### TECHNICAL FIELD

The present disclosure relates generally to respirator assemblies. In particular, it relates to lock mechanisms for securing components of respirator assemblies.

### BACKGROUND

A respirator may include a facepiece configured to be fit to a user's face and a respirator assembly including a respirator cartridge and a filter. Respirator assemblies may also include additional components for fitting the respirator assembly to the facepiece, including an adaptor configured to adapt a connector for the facepiece to the respirator cartridge. These components may be assembled during production of the respirator. If the components are not securely fastened together, then one or more of them may become loose or disconnected during use of the respirator.

Through applied effort, ingenuity, and innovation, Applicant has solved problems relating to securing components for respirator assemblies by developing solutions embodied in the present disclosure, which are described in detail below.

### SUMMARY

In general, embodiments of the present disclosure provide facepieces, respirator assemblies, respirators, methods of use, and/or the like.

In accordance with various embodiments of the present disclosure there is provided a respirator assembly including a connector having a connector base and a connector column, wherein the connector column has an inner and outer surface, and wherein the connector column defines connector threading on its outer surface; an adaptor having an adaptor base and an adaptor column, wherein the adaptor column has an inner and outer surface, wherein the adaptor column defines adaptor threading on its inner surface, wherein connector threading and the adaptor threading are configured to fit together such that the connector and the adaptor are operably engaged; and a respirator cartridge including a housing defining a fitment portion configured to receive the adaptor column such that the respirator cartridge and the adaptor are operably engaged.

In some embodiments, one or more of the connector threading and the adaptor threading are bayonet threads.

In some embodiments, the connector threading and the adaptor threading define one or more ramp angles between them when the adaptor and the connector are operably engaged.

In some embodiments, the one or more ramp angles are fifty degrees.

In some embodiments, the respirator assembly further includes a gasket disposed between the adaptor and the respirator cartridge, wherein the adaptor column further defines a lip on its outer surface, and wherein the gasket is configured to be operably engaged with the lip of the adaptor.

In some embodiments, the respirator cartridge is configured to receive one or more filters within the housing.

In some embodiments, the respirator assembly is configured to be operably engaged with a facepiece.

According to various embodiments, there is provided a respirator including: a respirator assembly having a connector including a connector base and a connector column, wherein the connector column has an inner and outer surface, and wherein the connector column defines connector threading on its outer surface; an adaptor including an adaptor base and an adaptor column, wherein the adaptor column includes an inner and outer surface, wherein the adaptor column defines adaptor threading on its inner surface, wherein the connector threading and the adaptor threading are configured to fit together such that the connector and the adaptor are operably engaged; and a respirator cartridge including a housing defining a fitment portion configured to receive the adaptor column such that the respirator cartridge and the adaptor are operably engaged; and a facepiece configured to be attached to a face of a user, the facepiece including one or more attachment slots configured to receive the respirator assembly.

In some embodiments, one or more of the connector threading and the adaptor threading are bayonet threads.

In some embodiments, the connector threading and the adaptor threading define one or more ramp angles between them when the adaptor and the connector are operably engaged.

In some embodiments, the one or more ramp angles are fifty degrees.

In some embodiments, the respirator further includes a gasket disposed between the adaptor and the respirator cartridge, wherein the adaptor column further defines a lip on its outer surface, and wherein the gasket is configured to be operably engaged with the lip of the adaptor.

In some embodiments, the respirator cartridge is configured to receive one or more filters within the housing.

In some embodiments, the facepiece further includes a band configured to secure the facepiece to the face of the user.

In some embodiments, the facepiece further includes one or more straps operably engaged to the band and configured to adjust the facepiece to the face of the user.

According to various embodiments, there is provided a method for using a respirator assembly, the method including: attaching, by a connector threading and an adaptor threading, a connector to an adaptor, wherein one or more of the connector threading and the adaptor threading are bayonet threads and define one or more ramp angles between them; securing, by one or more adaptor protrusions, the adaptor to a respirator cartridge; and inserting, by a base of the connector, the connector into an attachment slot of a facepiece.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a front elevation view of an example facepiece in accordance with various embodiments of the present disclosure;

FIG. 2 is an exploded view of an example respirator assembly in accordance with various embodiments of the present disclosure;

FIG. 3 is a top angle view of an example adaptor in accordance with various embodiments of the present disclosure;

FIG. 4 is an angled view of an example respirator connected to an example facepiece in accordance with various embodiments of the present disclosure;

FIG. 5 is a diagram showing example angles of example threads in an example respirator assembly in accordance with various embodiments of the present disclosure; and

FIG. 6 is a flow chart illustrating an example method of use for an example respirator assembly.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, one or more respirator assemblies may be fitted to a facepiece for use as a respirator. In some embodiments, the one or more respirator assemblies may include a connector, an adaptor, a gasket, and a respirator cartridge. In some embodiments, the connector and adaptor may be configured to fit together by means of threading on their respective surfaces. In some embodiments, the threading may be bayonet threading, and the ramp angle of the bayonet threading may be increased to an angle that increases the friction of the threaded connection, subsequently increasing the torque required to unthread the connector and adaptor. In some embodiments, the increased angle may increase the strength of the connection between the adaptor and the connector, making the components of the respirator assembly difficult to disengage.

In some embodiments, the connection formed by the threaded portions may be strong and difficult to disengage such that the components of the respirator assembly as securely fitted together. In some embodiments, the threaded portions may be disengaged only by deliberately manipulating one or more of the connector or the adaptor with respect to the other, such that the two components cannot be disengaged otherwise during normal operation (i.e., excluding any sudden blunt trauma or other catastrophic failure of the respirator assembly).

### Example Facepieces

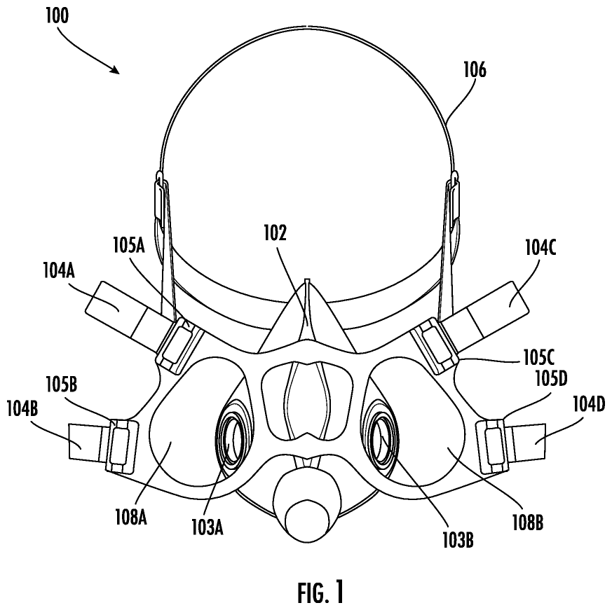

FIG. 1 shows a front elevation view of an example facepiece 100, according to various embodiments. In some embodiments, the facepiece 100 may be a facepiece for a respirator. In some embodiments, the facepiece 100 may be composed of a thermoplastic elastomer.

In some embodiments, the facepiece 100 may include a shell 102. In some embodiments, the shell 102 may include one or more attachment slots 103A and 103B. In some embodiments, the attachment slots 103A-B may be disposed in parallel positions on the shell 102. In some embodiments, the shell 102 may be placed over a user's face and, in particular, a user's nose and mouth such that the user's respiration is regulated through the shell 102. In some embodiments, the shell 102 may be made of plastic and may be deformable or semi-deformable to fit various face types for various users. In some embodiments, the attachment slots 103A-B may be configured to receive one or more components of a respirator assembly 200, as will be described in greater detail later in this disclosure.

In some embodiments, the facepiece 100 may include a plurality of straps 104A-D that may be adjusted to secure the facepiece 100 to various head shapes of various individuals. In some embodiments, the straps 104A-D may be secured through one or more respective loops 105A-D.

In some embodiments, the facepiece 100 may include a band 106. In some embodiments, the band 106 may be connected to the shell 102 by means of the plurality of straps 104A-D. In some embodiments, the band 106 may be configured to further secure the facepiece 100 to a user's head by wrapping the band 106 around the back of the user's head once the shell 102 is secured to the user's face. In some embodiments, the straps 104A-D may be configured to adjust the position of the band 106 with respect to the shell 102 (and, by extension, with respect to a user's head). For example, a user may pull on the straps 104A-D to tighten the facepiece 100 and vice-versa.

In some embodiments, the facepiece 100 may include one or more voids 108A and 108B. In some embodiments, the one or more voids 108A-B may be positioned adjacent to the attachment slots 103A-B. In some embodiments, the one or more voids 108A-B may be configured to receive one or more parts of a user's face. For example, users may put one or more of their ears through the one or more voids 108A-B when they are wearing the facepiece 100.

### Example Respirator Assemblies

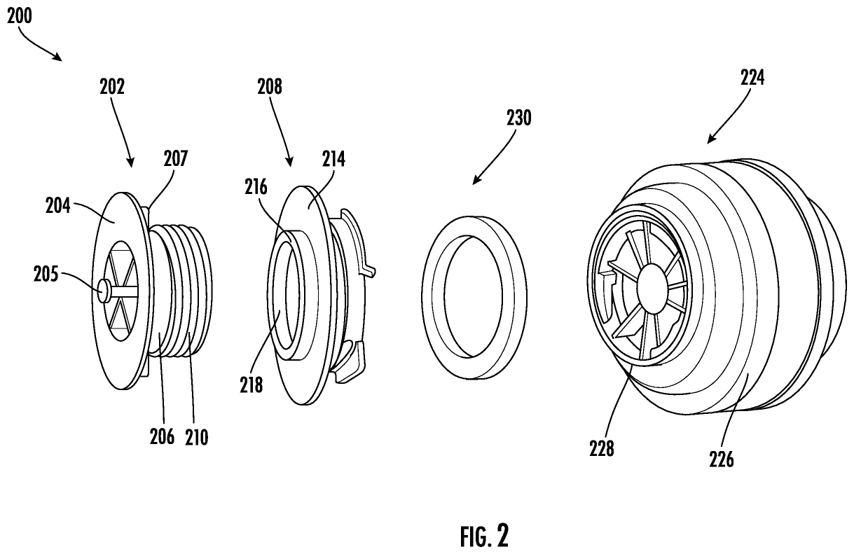

FIG. 2 shows an exploded view of an example respirator assembly 200, according to various embodiments, and as alluded to previously in this disclosure. In some embodiments, the respirator assembly 200 may include a connector 202. In some embodiments, the connector 202 may be a threaded connector. In some embodiments, the connector 202 may be configured to operably engage and/or fixedly attach the respirator assembly 200 to the facepiece 100. In some embodiments, the connector 202 may include a connector base 204 that may be substantially circular shaped and configured to be inserted into one or more of the attachment slots 103A-B of the facepiece 100. In some embodiments, the connector base 204 may include one or more fasteners 205 (e.g., one or more screws), which may be configured to further secure the connector base 204 to the attachment slots 103A-B. In some embodiments, there may be one or more corresponding fastener holes on the facepiece 100 (e.g., screw holes) configured to receive the one or more fasteners 205.

In some embodiments, the connector 202 may include a connector column 206 that may be hollow, substantially cylindrical shaped, and configured to slot into one or more other components of the respirator assembly 200. In some embodiments, the connector column 206 may include one or more connector threading 210 on its outer surface that may aid in forming this connection between the one or more other components of the respirator assembly 200. In some embodiments, the connector column 206 may include one or more connector protrusions 207 that may be configured to further secure the connector 202 to the one or more other components of the respirator assembly 200. In some embodiments, the one or more protrusions 207 may be positioned on one or more sides of the connector base 204.

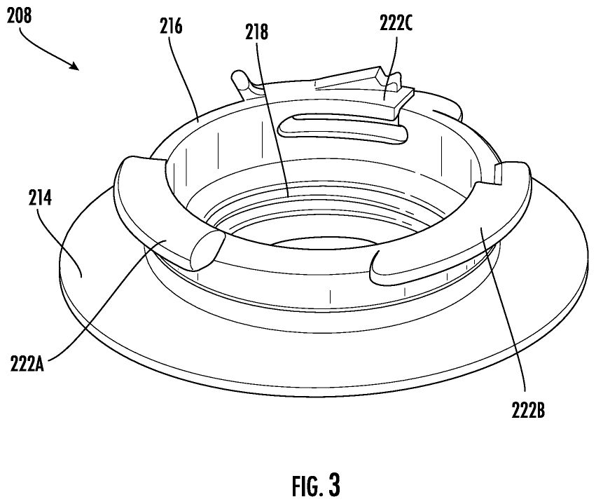

In some embodiments, and as shown in at least FIGS. 2 and 3, the respirator assembly may include an adaptor 208. In some embodiments, the adaptor 208 may be a threaded adaptor. In some embodiments, the adaptor 208 may be configured to operably engage and/or fixedly attach various components of the respirator assembly 200. In some embodiments, the adaptor 208 may be configured to operably engage and/or fixedly attach the connector 202 to a respirator cartridge 224. In some embodiments, the adaptor 208 may be substantially plastic.

In some embodiments, the connector 202 an/or the adaptor 208 may be composed of polypropylene and glass fiber material. In some embodiments, the connector 202 and/or the adaptor 208 may be composed of 70% polypropylene and 30% glass fiber material.

In some embodiments, the adaptor 208 may include an adaptor base 214. In some embodiments, the adaptor base 214 may be substantially circular. In some embodiments, the adaptor 208 may include an adaptor column 216. In some embodiments, the adaptor column 216 may be disposed through the adaptor base 214. In some embodiments, the adaptor column 216 may have an inner surface and an outer surface. In some embodiments, the adaptor column may include adaptor threading 218 defined on its inner surface. In some embodiments, the adaptor threading 218 may be configured to interface with the connector threading 210 and thereby form a threaded connection. In some embodiments, the adaptor column 216 may include a lip 220. In some embodiments, the adaptor column 216 may include one or more adaptor protrusions 222A-C. In some embodiments, the lip 220 and the one or more adaptor protrusions 222A-C may be disposed on the outer surface of the adaptor column 216.

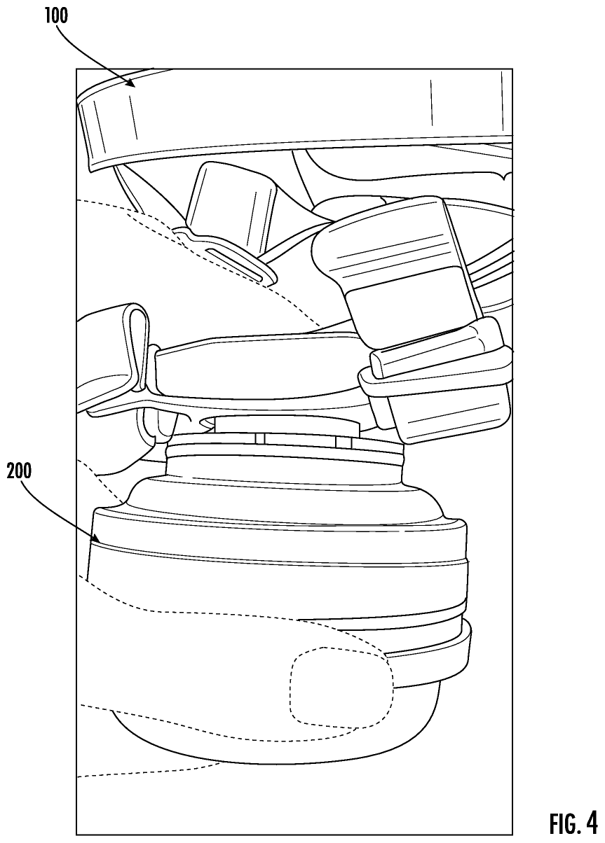

In some embodiments, and as shown in at least FIGS. 2 and 4, the respirator assembly 200 may include a respirator cartridge 224. In some embodiments, the respirator cartridge 224 may provide an assigned protection factor of 10 when the respirator cartridge 224 is fitted with a filter. In some embodiments, the respirator cartridge 224 may be configured to filter air for various particulates and hazards. In some embodiments, the respirator cartridge 224 may include a housing 226. In some embodiments, the housing 226 may be substantially cylindrical or spherical shaped. In some embodiments, the housing 226 may include a fitment portion 228 that may be configured to be fitted to the adaptor 208. In some embodiments, the one or more adaptor protrusions 222A-C may be configured to fit into the fitment portion 228 to further secure the adaptor 208 to the respirator cartridge 224. In some embodiments, the respirator cartridge 224 may include a filter configured to remove toxins and other environmental hazards as it passes through the respirator assembly 200. In some embodiments, the filter may be disposed within the housing 226. In some embodiments, the housing 226 may be configured to be opened such that the filter may be replaced as needed.

In some embodiments, the respirator assembly 200 may include a gasket 230. In some embodiments, the gasket 230 may be positioned between the respirator cartridge 230 and the adaptor 208. In some embodiments, the gasket 230 may be configured to fit around the adaptor column 216. In some embodiments, the gasket 230 may be secured in place by the lip 220 of the adaptor column 216. In some embodiments, the gasket 230 may be composed of silicon.

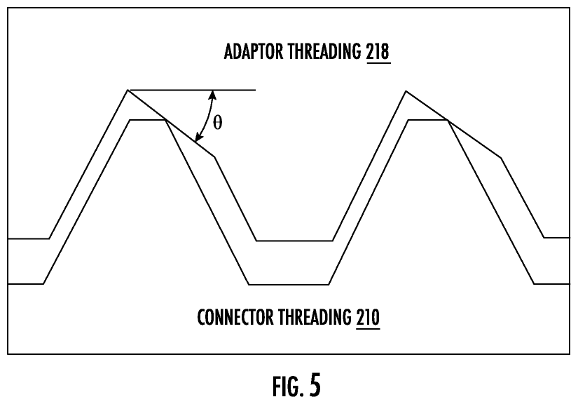

Referring now to FIG. 5, which illustrates a cross-sectional angle of interaction between the connector threading 210 and the adaptor threading 218 when the connector 202 and adaptor 208 are fitted together, in some embodiments, one or more of the connector threading 210 and the adaptor threading 218 may be bayonet threads. In some embodiments, the bayonet threads may have a ramp angle θ defined between them when the connector 202 and adaptor 208 are fitted together. In some embodiments, the ramp angle θ may be increased and thereby increase the friction between the connector threading 210 and the adaptor threading 218. In some embodiments, the increased friction may result in the adaptor 208 being more difficult to disengage from the connector 202. In some embodiments, the ramp angle θ may be 50 degrees.

### Example Methods of Use

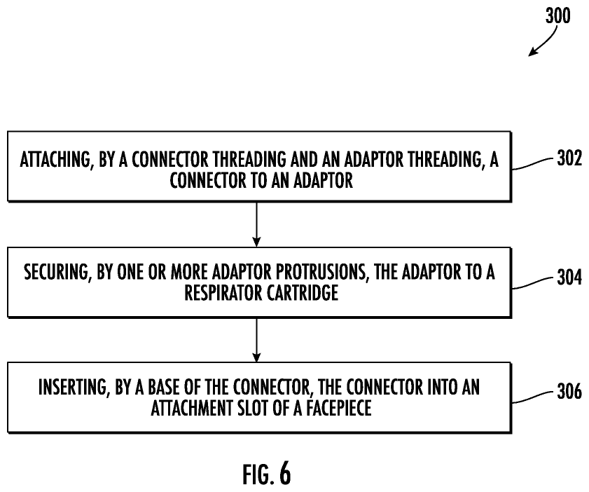

FIG. 6 shows a flow chart illustrating an example method 300 for using a respirator assembly. In some embodiments, the method 300 may be used with respect to the facepiece 100 and respirator assembly 200 and their various components, as previously described, but in some embodiments the method 300 may be used with other suitable systems, assemblies, and components, as desired. In some embodiments, one or more of the steps of the method 300 may be performed sequentially, and in some embodiments one or more of the steps of the method 300 may be performed simultaneously.

In some embodiments, the method 300 may include a first step 302 of attaching, by a connector threading and an adaptor threading, a connector to an adaptor. In some embodiments, the method 300 may include a second step 304 of securing, by one or more adaptor protrusions, the adaptor to a respirator cartridge. In some embodiments, the method 300 may include a step 306 of inserting, by a base of the connector, the connector into an attachment slot of a facepiece.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A respirator assembly comprising:
a connector comprising a connector base and a connector column,
wherein the connector column comprises an inner and outer surface, and
wherein the connector column defines connector threading on its outer surface;
an adaptor comprising an adaptor base and an adaptor column,
wherein the adaptor column comprises an inner and outer surface,
wherein the adaptor column defines adaptor threading on its inner surface,
wherein connector threading and the adaptor threading are configured to fit together such that the connector and the adaptor are operably engaged; and
a respirator cartridge comprising a housing defining a fitment portion configured to receive the adaptor column such that the respirator cartridge and the adaptor are operably engaged.

2. The respirator assembly of claim 1, wherein one or more of the connector threading and the adaptor threading comprise bayonet threads.

3. The respirator assembly of claim 2, wherein the connector threading and the adaptor threading define one or more ramp angles between them when the adaptor and the connector are operably engaged.

4. The respirator assembly of claim 3, wherein the one or more ramp angles are fifty degrees.

5. The respirator assembly of claim 1, further comprising
a gasket disposed between the adaptor and the respirator cartridge,
wherein the adaptor column further defines a lip on its outer surface, and
wherein the gasket is configured to be operably engaged with the lip of the adaptor.

6. The respirator assembly of claim 1, wherein the respirator cartridge is configured to receive one or more filters within the housing.

7. The respirator assembly of claim 1, wherein the respirator assembly is configured to be operably engaged with a facepiece.

8. A respirator comprising:
a respirator assembly comprising:
a connector comprising a connector base and a connector column,
wherein the connector column comprises an inner and outer surface, and
wherein the connector column defines connector threading on its outer surface;
an adaptor comprising an adaptor base and an adaptor column,
wherein the adaptor column comprises an inner and outer surface,
wherein the adaptor column defines adaptor threading on its inner surface,
wherein connector threading and the adaptor threading are configured to fit together such that the connector and the adaptor are operably engaged; and
a respirator cartridge comprising a housing defining a fitment portion configured to receive the adaptor column such that the respirator cartridge and the adaptor are operably engaged; and
a facepiece configured to be attached to a face of a user, the facepiece comprising one or more attachment slots configured to receive the respirator assembly.

9. The respirator of claim 8, wherein one or more of the connector threading and the adaptor threading comprise bayonet threads.

10. The respirator of claim 9, wherein the connector threading and the adaptor threading define one or more ramp angles between them when the adaptor and the connector are operably engaged.

11. The respirator claim 10, wherein the one or more ramp angles are fifty degrees.

12. The respirator claim 8, further comprising
a gasket disposed between the adaptor and the respirator cartridge,
wherein the adaptor column further defines a lip on its outer surface, and
wherein the gasket is configured to be operably engaged with the lip of the adaptor.

13. The respirator of claim 8, wherein the respirator cartridge is configured to receive one or more filters within the housing.

14. The respirator of claim 8, wherein the facepiece further comprises a band configured to secure the facepiece to the face of the user.

15. The respirator of claim 14, wherein the facepiece further comprises one or more straps operably engaged to the band and configured to adjust the facepiece to the face of the user.

16. A method for using a respirator assembly, the method comprising:
attaching, by a connector threading and an adaptor threading, a connector to an adaptor,
wherein one or more of the connector threading and the adaptor threading comprise bayonet threads and define one or more ramp angles between them;
securing, by one or more adaptor protrusions, the adaptor to a respirator cartridge; and
inserting, by a base of the connector, the connector into an attachment slot of a facepiece.
